(19) United States
(12) Patent Application Publication
(10) Pub. No.: US 2026/0236242 A1
(43) Pub. Date: Aug. 13, 2026

(54) OPTIMIZATION DEVICE AND OPTIMIZATION METHOD

(71) Applicant: Fujitsu Limited, Kawasaki-shi (JP)

(72) Inventor: Toshiyuki ICHIBA, Toronto (CA)

(73) Assignee: Fujitsu Limited, Kawasaki-shi (JP)

(21) Appl. No.: 19/441,977

(22) Filed: Jan. 7, 2026

(30) Foreign Application Priority Data
Feb. 10, 2025 (JP) 2025-020298

(51) Int. Cl. G06F 8/41

(52) U.S. Cl. CPC G06F 8/443

(57) ABSTRACT

An optimization device includes a processor configured to generate a first DFG corresponding to a first loop and a second DFG corresponding to a second loop for a program in which an incomplete nested loop in which a first arithmetic operation result for each loop of the first loop is sequentially used in an arithmetic operation for each loop of the second loop of a second layer included in the first loop of a first layer is present, and arrange a first data transfer node between an output portion of the first arithmetic operation result in the first DFG and an input portion of the first arithmetic operation result in the second DFG, connect the first DFG and the second DFG by the first data transfer node, and generate a third DFG of the program.

### CROSS-REFERENCE TO RELATED APPLICATION

This application is based upon and claims the benefit of priority of the prior Japanese Patent Application No. 2025-020298, filed on Feb. 10, 2025, the entire contents of which are incorporated herein by reference.

### FIELD

The embodiments discussed herein are related to an optimization device and an optimization method.

### BACKGROUND

In recent years, as one of data processing devices, CGRAs (coarse-grained reconfigurable architectures) having excellent calculation performance and excellent energy efficiency accompanying a data process have attracted attention. CGRA is a technology of a processor having a structure in which arithmetic units called PE (processing elements) including an arithmetic unit, a register, and the like are arranged in a two-dimensional array. The CGRA can reconfigure an arithmetic operation content executed by the PE during operation and a data transfer path between the PEs. The processor itself in which the PEs are arranged in a two-dimensional array may be referred to as a CGRA.

Execution of the program using the CGRA is performed in the following procedure. The program to be executed is converted into a data flow graph (DFG) using a compiler. The DFG includes nodes indicating arithmetic operations and directed edges indicating data dependencies between arithmetic operations. The directed edge indicates that output data of a source node is used as input data of a destination node. Next, based on the DFG, the arithmetic operation content executed by each PE and the wiring of the data between the PEs are determined according to the configuration of each PE of the CGRA. The determination of the arithmetic operation content and the wiring of the data between the PEs is called mapping. Thereafter, data is input to the CGRA for which mapping is completed, and the CGRA executes the arithmetic operation using the input data.

As an arithmetic operation method of the CGRA, there is a method in which a timing at which data is input and output between PEs and a timing at which the PE performs the arithmetic operation are determined at the time of mapping. The timing may be expressed as a cycle. The GCRA adopting this arithmetic operation method may be referred to as a "static scheduled CGRA". In the static schedule CGRA, in a case where data is irregularly stored in a local memory, data is rearranged at the time of data transfer, and it is difficult to continuously input data every cycle. Therefore, in the static schedule CGRA, when data is continuously input every cycle, it is common to input continuous data on the local memory to each PE of the CGRA.

On the other hand, a program for causing CGRA to perform the arithmetic operation includes a program having a structure of an incomplete nested loop. In the incomplete nested loop, there is a process having data dependency between nested loops, that is, between loops having a hierarchical structure. For example, a program in which the incomplete nested loop is present is processed in the following order. In the process of the loop in a first layer, a processing result is obtained for each loop. Using the processing result for each loop of the loop of the first layer, the execution of the process of the loop of a second layer included in the loop of the first layer is repeated, and the loop is completed. When all the process of the loop of the second layer is completed, the process of the loop next to the loop of the first layer is started. In the process of the loop of the first layer, the process of the next loop is executed using the processing result in the previous loop. That is, it can be said that the process of the loop of the first layer has an internal state. For example, the process of the loop of the first layer is a process of sequentially adding the number of loops, or the like. The process of the first loop is called an "outer process", and the process of the second loop is called an "inner process".

In a case where a program having such an incomplete nested loop structure is executed, in the static schedule CGRA, when the outer process is executed and when the processing result of the outer process is sent to the inner process are determined at the time of mapping. Therefore, as a method for generating a DFG of an incomplete nested loop to be mapped to the static schedule CGRA, a method for eliminating the incomplete nested loop in the program to form one nested loop is considered.

As a method for eliminating the incomplete nested loop in the program, there is a method for rewriting a loop using a compiler optimization technology. For example, by using a technology called Loop Flattening or Loop Coalescing in which a nested loop is formed into one loop, the outer process is incorporated into the inner process as an if statement. Furthermore, conversion is performed to eliminate the if statement incorporated in the inner process.

There has also been proposed a technology for checking whether at least one pattern is identified among a plurality of system calls, analyzing the identified pattern to determine whether correction of the calculation grid is in need, and correcting the calculation grid to optimize the called function.

Japanese Laid-open Patent Publication No. 2020-530175

### SUMMARY

According to an aspect of an embodiment, an optimization device includes a processor configured to generate a first DFG corresponding to a first loop and a second DFG corresponding to a second loop for a program in which an incomplete nested loop in which a first arithmetic operation result for each loop of the first loop is sequentially used in an arithmetic operation for each loop of the second loop of a second layer included in the first loop of a first layer is present, and arrange a first data transfer node between an output portion of the first arithmetic operation result in the first DFG and an input portion of the first arithmetic operation result in the second DFG, the first data transfer node holding the first arithmetic operation result output from the first DFG, updating the held first arithmetic operation result, and outputting the held first arithmetic operation result to the second DFG, connect the first DFG and the second DFG by the first data transfer node, and generate a third DFG of the program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a hardware configuration diagram of an arithmetic device equipped with a CGRA;

FIG. 2 is a hardware configuration diagram of the CGRA;

FIG. 3 is a block diagram of a DFG generation device according to a first embodiment;

FIG. 4 is a diagram illustrating an outline of DFG generation and mapping;

FIG. 5 is a diagram illustrating an example of a code of a program including an incomplete nested loop;

FIG. 6 is a diagram of an example of a DFG illustrating a loop;

FIG. 7 is a diagram illustrating an example of a configuration of a PE;

FIG. 8 is a diagram illustrating a connection state of an uppermost PE;

FIG. 9 is a diagram illustrating an outline of DFG generation by the DFG generation device according to the first embodiment;

FIG. 10 is a diagram illustrating an example of mapping by the DFG generation device according to the first embodiment;

FIG. 11 is a diagram illustrating an example of data stored in a local memory in the DFG generation device according to the first embodiment;

FIG. 12 is a diagram illustrating an example of loop rewriting using a compiler optimization technology according to the first embodiment;

FIG. 13 is a diagram illustrating an example of mapping in a case where a loop according to the first embodiment is rewritten;

FIG. 14 is a flowchart of a DFG generation process by the DFG generation device according to the first embodiment;

FIG. 15 is a diagram illustrating an example of a program compatible with parallel execution;

FIG. 16 is a diagram illustrating an example of a DFG and mapping according to a second embodiment;

FIG. 17 is a diagram illustrating an example of mapping in a case where a loop according to the second embodiment is rewritten;

FIG. 18 is a diagram illustrating comparison of the number of PEs to be used in a parallel execution program;

FIG. 19 is a diagram illustrating an example of generation of a DFG by a DFG generation device according to a third embodiment;

FIG. 20 is a diagram illustrating an example of mapping by the DFG generation device according to the third embodiment;

FIG. 21 is a first diagram illustrating an example of loop rewriting using a compiler optimization technology according to the third embodiment;

FIG. 22 is a second diagram illustrating an example of loop rewriting using a compiler optimization technology according to the third embodiment; and

FIG. 23 is a diagram illustrating an example of mapping in a case where a loop according to the third embodiment is rewritten.

### DESCRIPTION OF EMBODIMENTS

However, in a case where the loop is rewritten using the compiler optimization technology, there is a possibility that the arithmetic operation in the loop increases. When the arithmetic operation increases, the number of PEs for which the arithmetic operation is performed increases, and the number of PEs that can be used for other arithmetic operations decreases. Therefore, it is difficult to improve the arithmetic operation efficiency of the entire CGRA. In addition, in the technology of correcting the calculation grid based on pattern identification between system calls, the correspondence to the incomplete nested loop is not considered, and it is difficult to improve the arithmetic operation efficiency of the entire CGRA when the incomplete nested loop is present.

Preferred embodiments will be explained with reference to accompanying drawings. Note that the optimization device and the optimization method disclosed in the present application are not limited by the following embodiments.

### (a) First Embodiment

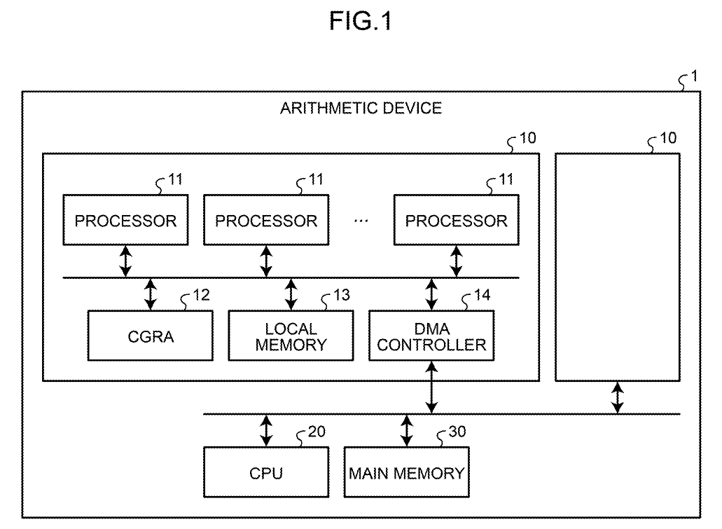

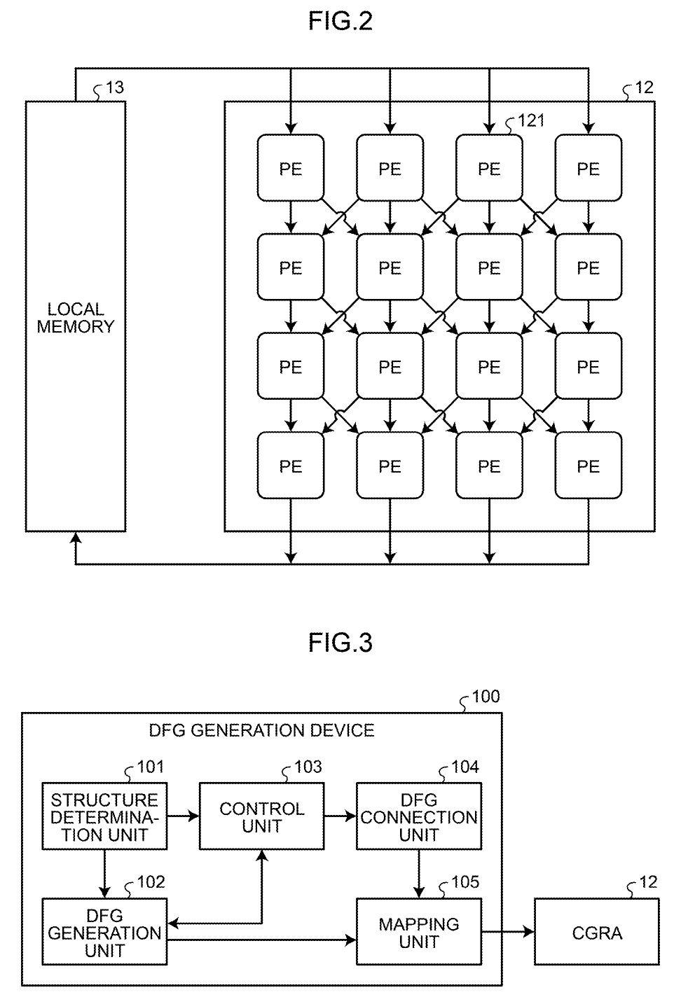

FIG. 1 is a hardware configuration diagram of an arithmetic device equipped with a CGRA. In addition, FIG. 2 is a hardware configuration diagram of the CGRA.

An arithmetic device 1 includes an accelerator 10, a CPU (central processing unit) 20, and a main memory 30. The accelerator 10, the CPU 20, and the main memory 30 are connected via a bus.

The CPU 20 includes caches such as a L (layer) 1

cache and an L2 cache. There may be a plurality of CPUs 20. The CPU 20 can transmit and receive data to and from a CGRA 12 via the main memory 30 by a DMA controller 14.

Further, the CPU 20 converts the given program into a DFG using a compiler. The DFG includes information on a node for which a predetermined operation to be executed is set and connection between nodes. Then, the CPU 20 performs mapping on the CGRA 12 mounted on the accelerator 10 based on the generated DFG.

The accelerator 10 includes one or more processors 11, a CGRA 12, a local memory 13, and a direct memory access (DMA) controller 14. Although two accelerators are illustrated in FIG. 1, this is an example, and the number of accelerators 10 may be one or three or more. Further, the accelerator 10 may be mounted on the same chip as the CPU 20, or may be disposed on a substrate different from the chip of the CPU 20 and connected to the CPU 20 by a PCIe (peripheral component interconnect express) bus or the like.

The CGRA 12 performs an arithmetic operation according to the mapping and executes various data processes. The CGRA 12 can transmit and receive data to and from the CPU 20 via the local memory 13 by the DMA controller 14.

More specifically, as illustrated in FIG. 2, the CGRA 12 includes PEs 121 which are arithmetic units arranged in a two-dimensional array. Upon mapping by the CPU 20, the CGRA 12 sets the PE 121 to be used according to the designated DFG, sets the arithmetic operation to be executed by each PE 121, and connects the PEs 121 to each other. Each of the nodes included in the DFG is allocated to the PE 121. The PE 121 to which a specific node is allocated executes a predetermined arithmetic operation set for the specific node. The DFG is information of an arithmetic circuit configuration including an arithmetic unit to be used, a connection path between the arithmetic units, and an output path of an arithmetic operation result. The CGRA 12 receives an input of data used for the arithmetic operation and executes the arithmetic operation using the PE 121 to which each node of the DFG is allocated by mapping.

The processor 11 may execute the calculation that is not supported by the CGRA 12 or the arithmetic operation that degrades performance when executed by the CGRA 12. The DMA controller 14 transfers the data stored in the local memory 13 to the main memory 30. The DMA controller 14 transfers the data stored in the main memory 30 to the local memory 13.

The main memory 30 is a main storage device. As the main memory 30, for example, a DRAM (dynamic random access memory) can be used.

FIG. 3 is a block diagram of a DFG generation device according to a first embodiment. The DFG generation device 100 corresponds to a DFG generation function of the arithmetic device 1. The DFG generation device 100 is implemented by the CPU 20, the main memory 30, the DMA controller 14, and the like.

For example, the DFG generation device 100 generates a DFG in accordance with a code of a program. Then, based on the generated DFG, the DFG generation device 100 determines the PE 121 subjected to the arithmetic operation according to the arrangement of the PE 121 in the CGRA 12, determines the arithmetic operation content to be executed by each PE 121, and determines the connection between the PEs 121. Thereafter, the DFG generation device 100 performs mapping on the CGRA 12 with the determined configuration, and causes the CGRA 12 to perform allocation of the arithmetic operation to each PE 121 and connection between the PEs 121.

As illustrated in FIG. 3, the DFG generation device 100 includes a structure determination unit 101, a DFG generation unit 102, a control unit 103, a DFG connection unit 104, and a mapping unit 105.

The structure determination unit 101 receives an input of a program to be executed from an input device (not illustrated) or the like. Next, the structure determination unit 101 analyzes the acquired code of the program and determines whether an incomplete nested loop is present in the program.

In a case of a program in which the incomplete nested loop is not present, the structure determination unit 101 transmits the program to the DFG generation unit 102 and requests generation of a DFG corresponding to the program. On the other hand, in a case of a program in which the incomplete nested loop is present, the structure determination unit 101 transmits the program to the control unit 103 and requests generation of the DFG according to the incomplete nested loop.

The control unit 103 receives an input of a program in which the incomplete nested loop is present from the structure determination unit 101 together with a request for generating a DFG according to the incomplete nested loop. Here, in order to simplify the description, a program that does not include processes other than the outer process and the inner process constituting the incomplete nested loop will be described as an example. Hereinafter, the loop of the first layer that executes the outer process is referred to as a first loop, and the loop of the second layer that executes the inner process is referred to as a second loop.

The control unit 103 requests the DFG generation unit 102 to generate a DFG of each loop of each layer in a program in which the incomplete nested loop is present. Thereafter, the control unit 103 receives inputs of the DFG of the first loop and the DFG of the second loop from the DFG generation unit 102. Next, the control unit 103 outputs the DFG of the first loop and the DFG of the second loop to the DFG connection unit 104 to request connection of the DFG.

In the case of a program not including the incomplete nested loop, the DFG generation unit 102 receives a request for generation of the DFG corresponding to the program from the structure determination unit 101 together with input of the program. Then, if there is a loop in the program, the DFG generation unit 102 expands the loop, extracts an arithmetic operation in the program, and generates one DFG according to an input/output relationship of data of each arithmetic operation. Thereafter, the DFG generation unit 102 outputs the generated DFG to the mapping unit 105.

In addition, in the case of the program including the incomplete nested loop, the DFG generation unit 102 receives, from the control unit 103, a request for generating a DFG of each loop of each layer in the program in which the incomplete nested loop is present. Then, the DFG generation unit 102 analyzes the code of the program and sequentially selects the first layer and the second layer from the loop layer.

When the first layer is selected, the DFG generation unit 102 generates the DFG of the first loop using the code of the first loop. Further, when the second layer is selected, the DFG generation unit 102 generates the DFG of the second loop using the code of the second loop. Thereafter, the DFG generation unit 102 outputs the generated DFG of the first loop and the generated DFG of the second loop to the control unit 103.

Here, in the incomplete nested loop, a first arithmetic operation result of each loop of the first loop is sequentially used in the operation of each loop of the second loop of the second layer included in the first loop of the first layer. Then, the arithmetic operation result by the first loop output from the first loop and used for arithmetic operation in the second loop corresponds to an example of the "first arithmetic operation result". Further, the DFG of the first loop corresponds to an example of the "first DFG". Further, the DFG of the second loop corresponds to an example of the "second DFG". That is, the DFG generation unit 102 generates a first DFG corresponding to the first loop and a second DFG corresponding to the second loop for a program in which the incomplete nested loop is present. When the structure determination unit 101 determines that the program includes the incomplete nested loop, the DFG generation unit 102 generates a first DFG and a second DFG.

The DFG connection unit 104 receives inputs of the DFG of the first loop and the DFG of the second loop from the control unit 103. Next, the DFG connection unit 104 generates a data transfer node that performs setting for receiving input of timing information, holding of the input data, outputting of the held data, and a process of updating the held data according to the timing information.

Here, the data transfer node generated by the DFG connection unit 104 corresponds to an example of a "first data transfer node". That is, the DFG connection unit 104 generates a first data transfer node that holds the first arithmetic operation result output from the first DFG, updates the held first arithmetic operation result, and outputs the held first arithmetic operation result to the second DFG.

The DFG connection unit 104 disposes a data transfer node in a portion having a data dependency relationship between the first loop and the second loop. Then, the DFG connection unit 104 connects the DFG of the first node and the DFG of the second node via the data transfer node, and generates the DFG of the program to be executed. For example, the DFG connection unit 104 connects a node that outputs an arithmetic operation result in the DFG of the first node to an input of the data transfer node, and further connects an output of the data transfer node to a node that receives an input of the arithmetic operation result of the DFG of the first node of the second node. Thereafter, the DFG connection unit 104 outputs the generated DFG of the program to be executed to the mapping unit 105.

Here, the DFG of the program generated by the DFG connection unit 104 connecting the first node and the second node via the data transfer node corresponds to an example of the "third DFG". That is, the DFG connection unit 104 arranges the first data transfer node between the output portion of the first arithmetic operation result in the first DFG and the input portion of the first arithmetic operation result in the second DFG. Then, the DFG connection unit 104 connects the first DFG and the second DFG by the first data transfer node to generate a third DFG of the program. More specifically, the DFG connection unit 104 generates the third DFG including the first data transfer node to which the timing information is input and which updates the first arithmetic operation result held based on the timing information.

Here, the data transfer node can change the timing of outputting and updating the data according to the input timing information. For example, the PE 121 to which the data transfer node is allocated can change the timing of outputting data according to timing information input from software operating in an external device.

As a method for changing the timing, for example, the following method can be considered. The timing for outputting data may be set by the PE 121 to which the data transfer node is allocated receiving an input of a flag indicating whether data is held or updated in each cycle. The PE 121 to which the data transfer node is allocated updates the held data at the timing of receiving the input of the flag indicating the update of the data. In this case, the timing at which the flag indicating the update of the data is input is changed, so that the timing of the update of the data is changed in the PE 121 to which the data transfer node is allocated.

As described above, the DFG connection unit 104 can generate the third DFG including the first data transfer node that updates the held first arithmetic operation result when the flag indicating the holding or update is input as the timing information and the flag indicating the update is input.

In addition, the timing to output data may be set by notifying the PE 121 to which the data transfer node is allocated of the number of cycles for holding data. After updating the data, the PE 121 to which the data transfer node is allocated performs a countdown for each cycle from the notified number of cycles, updates the data held at the timing when the count becomes 0, and resets the count to the notified number of cycles. In this case, the timing of updating the data is changed in the PE 121 to which the data transfer node is allocated by changing the cycle of holding the data. The number of cycles may be preset in the data transfer node, or may be given to the PE 121 as input data at the time of data input.

This number of cycles corresponds to an example of the "data holding period". That is, the DFG connection unit 104 can generate the third DFG including the first data transfer node that updates the held first arithmetic operation result when the information indicating the data holding period is input as the timing information and the data holding period has elapsed.

The mapping unit 105 receives an input of a DFG of a program to be executed. Then, the mapping unit 105 performs mapping on the CGRA 12 according to the input DFG. In this manner, the mapping unit 105 maps the third DFG generated by the DFG connection unit 104 to the CGRA 12.

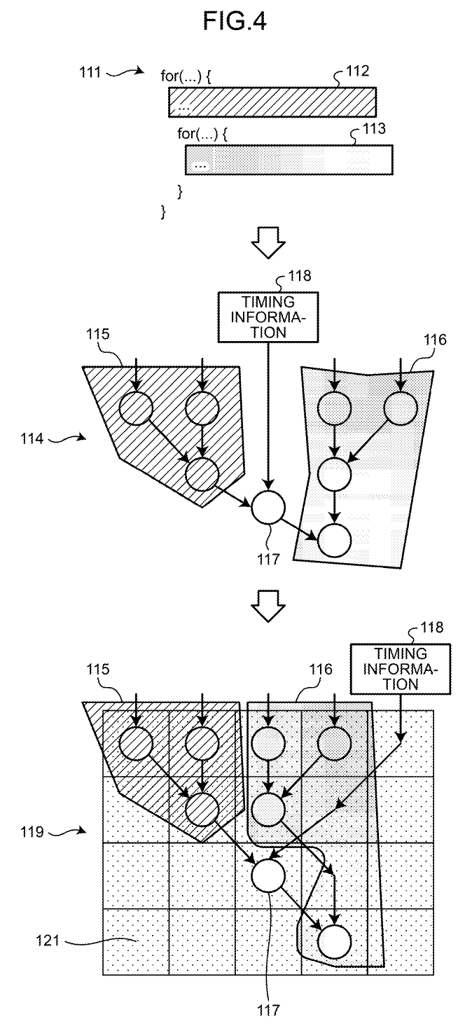

FIG. 4 is a diagram illustrating an outline of DFG generation and mapping. Here, an outline of a process of generating a DFG and mapping the generated DFG by the DFG generation device 100 according to the present embodiment will be described with reference to FIG. 4.

Upon receiving the input of the program having a code 111, the structure determination unit 101 confirms that a first loop 112 and a second loop 113 are present in a code 111.

Next, in response to an instruction from the control unit 103, the DFG generation unit 102 generates a DFG 115 from the first loop 112. In addition, the DFG generation unit 102 generates a DFG 116 from the second loop 113.

Next, the DFG connection unit 104 generates a data transfer node 117 that holds the arithmetic operation result output from the DFG 115, updates the arithmetic operation result held in response to the input of the timing information 118, and outputs the held arithmetic operation result to the DFG 116. Next, the DFG connection unit 104 disposes the data transfer node 117 at a portion where there is a data dependency relationship between the output of the DFG 115 and the input of the DFG 116. Then, the DFG connection unit 104 connects the DFG 115 and the DFG 116 via the data transfer node 117 to generate a DFG 114.

As illustrated in a mapping result 119, the mapping unit 105 allocates each node of the DFG 114 to each PE 121 and maps the DFG 114 to the CGRA 12. In addition, the mapping unit 105 performs mapping such that the timing information 118 is input to the PE 121 to which the data transfer node 117 is allocated.

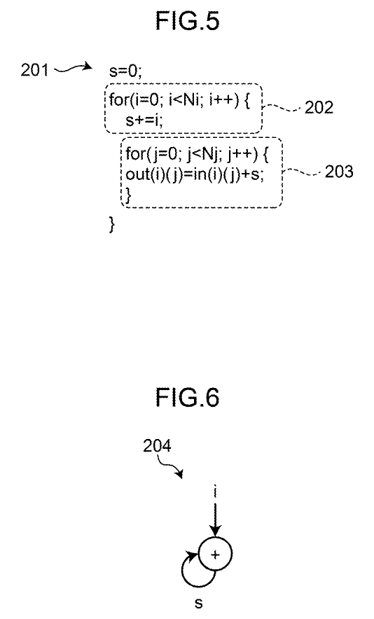

Next, generation of the DFG of the program including the incomplete nested loop will be described using a specific example. FIG. 5 is a diagram illustrating an example of a code of a program including an incomplete nested loop. Various settings used in the description here will be described.

Here, a program of a code 201 illustrated in FIG. 5 is a target of generation of the DFG. The code 201 includes an incomplete nested loop having a first loop 202 and a second loop 203.

In addition, FIG. 6 is a diagram of an example of the DFG illustrating the loop. Here, the DFG generation unit 102 generates "s + = i" in the first loop 202 as a DFG 204 illustrated in FIG. 6. Further, in the DFG 204, it is difficult to express both the initialization of s = 0 and s + = i by one DFG. Therefore, the DFG generation unit 102 sets the DFG 204 such that s = 0 at the start of execution.

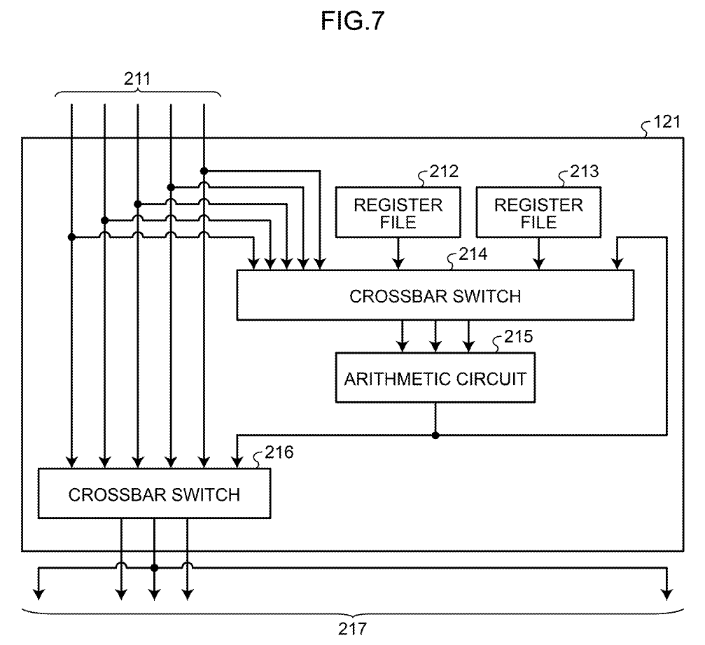

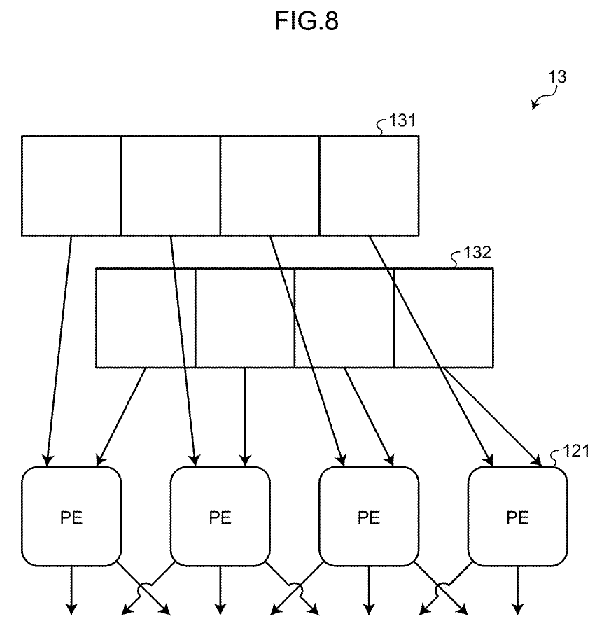

FIG. 7 is a diagram illustrating an example of a configuration of the PE. As illustrated in FIG. 7, the PE 121 described here includes five input paths 211, register files 212 and 213, crossbar switches 214 and 216, an arithmetic circuit 215, and three output paths 217.

The PE 121 receives inputs to three of the input paths 211 from the PE 121 immediately above in FIG. 3. In addition, the PE 121 receives inputs to two of the input paths 211 one by one from each of the two PEs 121 obliquely above in FIG. 3. However, the uppermost PE 121 in FIG. 2 receives an input of data from the local memory 13.

FIG. 8 is a diagram illustrating a connection state of the uppermost PE. In the present embodiment, the local memory 13 includes data output units 131 and 132. The data output units 131 and 132 each have a continuous data storage area. The data output unit 131 sequentially outputs the consecutive data of the number of PEs 121 among the data stored in the consecutive data storage areas to each of the uppermost PEs 121. The data output unit 131 repeats outputting to each of the uppermost PEs 121 along the arrangement of continuous data. Similarly, the data output unit 132 sequentially outputs the consecutive data of the number of PEs 121 among the data stored in the consecutive data storage areas to each of the uppermost PEs 121.

Returning to FIG. 6, the description will be continued. In the PE 121 in which any of the diagonally upper PEs 121 is not present, data is input to the four input paths 211 from the PE 121 immediately above and one diagonally upper PE 121. The lowermost PE 121 outputs data to the local memory 13 using one of the output paths 217.

The register files 212 and 213 can hold constants. The register files 212 and 213 can output the held constants to the crossbar switch 214. The register files 212 and 213 receive an input from an external device and hold a specified constant.

For example, the register files 212 and 213 can hold constants used for arithmetic operations. Furthermore, in a case where the number of cycles is given as the timing information, the register files 212 and 213 can hold the given number of cycles.

The crossbar switch 214 can receive inputs from each of the four input paths 211 and the register files 212 and 213. Then, the crossbar switch 214 outputs the input data to the arithmetic circuit 215.

The arithmetic circuit 215 can execute various arithmetic operations such as addition, subtraction, and multiplication. The arithmetic circuit 215 executes an arithmetic operation designated in advance using the data input from the crossbar switch 214. The arithmetic circuit 215 can selectively output the arithmetic operation result to either the crossbar switch 214 or the crossbar switch 216. In addition, the arithmetic circuit 215 can determine the update timing of the data using the data output from the register file 212. The arithmetic circuit 215 has a function of updating data. That is, the arithmetic circuit 215 can perform loop process. For example, the arithmetic circuit 215 can calculate s + = i in the first loop 202 illustrated in FIG. 4.

In the output path 217, a specific path of one of the three output paths branches into three paths, and three targets can be output using the paths. In the output path 217, three output paths are connected to the PE 121 immediately below in FIG. 3. Further, in the output path 217, outputs other than those connected to the PE 121 immediately below the specific path branched into three paths are connected to the two diagonally lower PEs 121.

Further, here, the PE 121 to which the data transfer node is allocated determines output and update of data according to the input of a flag indicating hold or update of data.

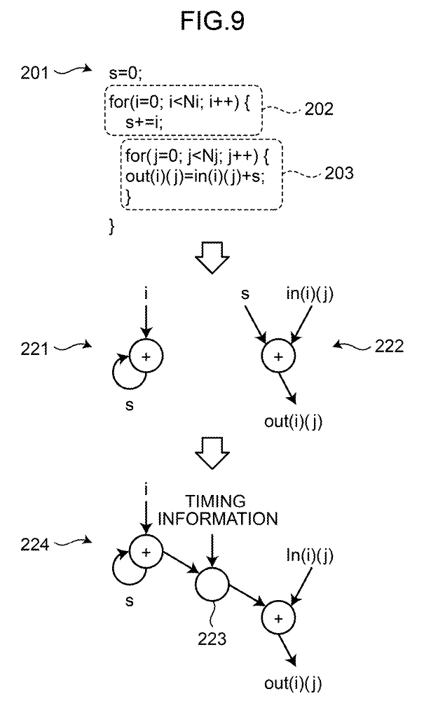

With the above setting, the DFG generation device 100 executes a DFG generation process described below. FIG. 9 is a diagram illustrating an outline of DFG generation by the DFG generation device according to the first embodiment. The DFG generation process will be described with reference to FIG. 9.

The control unit 103 requests the DFG generation unit 102 to create a DFG of the first loop 202 and a DFG of the second loop 203. Upon receiving the request from the control unit 103, the DFG generation unit 102 generates a DFG 221 from the code of the first loop 202 in the code 201. The DFG 221 performs an arithmetic operation using i that is input data from the local memory 13, and calculates s as an arithmetic operation result. In addition, the DFG generation unit 102 generates a DFG 222 from the code of the second loop 203 in the code 201. The DFG 222 performs an arithmetic operation using s which is an arithmetic operation result of the DFG 221 and In (i)(j) which is input data from the local memory 13, and outputs out (i)(j) as an arithmetic operation result.

The DFG connection unit 104 generates a data transfer node 223 that holds and updates the arithmetic operation result of the DFG 221 and receives the input of the timing information to update the held arithmetic operation result. Then, the DFG connection unit 104 connects an output path of s, which is an arithmetic operation result of the DFG 221, to an input path of the data transfer node 223. Further, the DFG connection unit 104 connects an output path of the data transfer node 223 to an input path of s which is an arithmetic operation result of the DFG 221, and generates a DFG 224. Thus, the DFG connection unit 104 completes generation of the DFG 224 of the program having the code 201.

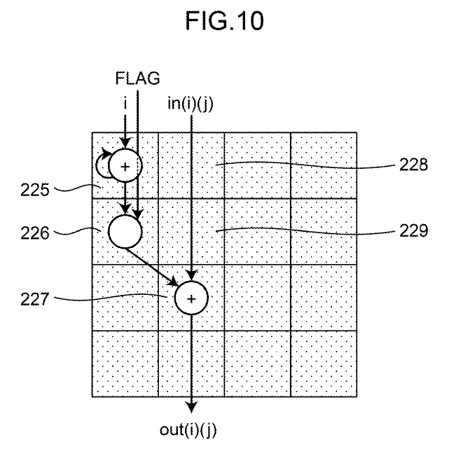

FIG. 10 is a diagram illustrating an example of mapping by the DFG generation device according to the first embodiment. FIG. 10 is an example of a mapping result of the DFG 224 of the program having the code 201 generated in FIG. 9. Each lattice in FIG. 10 represents one PE 121.

As illustrated in FIG. 10, for example, the mapping unit 105 allocates a node for performing the arithmetic operation of the DFG 221 to a PE 225. In addition, the mapping unit 105 allocates the data transfer node 223 to a PE 226. Further, the mapping unit 105 performs mapping such that a flag indicating update or holding is input to the PE 226 as the timing information. Further, the mapping unit 105 allocates a node for performing the arithmetic operation of the DFG 222 to a PE 227. An arrow indicates the flow of data, and the PE 121 through which the arrow passes allows the data to pass. In FIG. 10, the PE 121 that has not performed the arithmetic operation including the PE 121 that allows data to pass has a possibility of being able to execute other arithmetic operations.

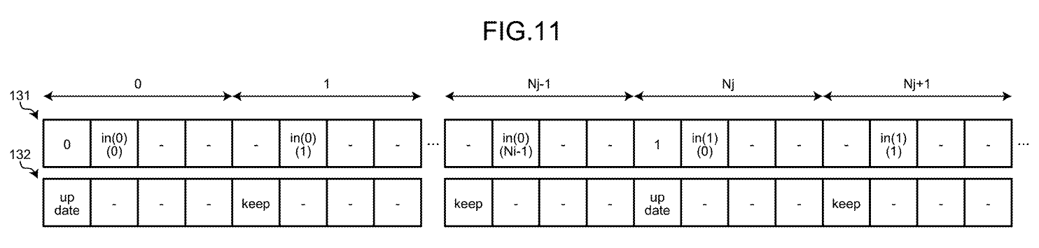

FIG. 11 is a diagram illustrating an example of data stored in a local memory in the DFG generation device according to the first embodiment. FIG. 11 illustrates a data storage state in data output units 131 and 132 of the local memory 13 corresponding to the mapping result illustrated in FIG. 10.

FIG. 11 illustrates a data storage area included in each of the data output units 131 and 132. In the data storage area, data is sequentially stored with the left end as a head toward a paper surface. In FIG. 11, the number of cycles at which the data stored in each storage area is output is illustrated above the arrangement of the data storage areas. In this case, since the four PEs 121 are arranged, both the data output units 131 and 132 output data from the four data storage areas arranged in order from the head to the four PEs 121 every cycle.

In the data output unit 131, i(i = 1, 2,...), which is an input value of the arithmetic operation of the first loop 202, is stored in the head data storage area of the four data storage areas from which data for each cycle is output. However, in the arithmetic operation of the first loop 202, since the next arithmetic operation is started after the arithmetic operation of all the loops of the second loop 203 is completed, i is stored with an interval of cycles corresponding to the loops of the second loop 203. In addition, in the data output unit 131, in(i)(j) (j = 1, 2,...), which is one input value of the arithmetic operation of the second loop, is stored in the second data storage area of the four data storage areas from which data for each cycle is output.

In the data output unit 132, a flag indicating timing information is stored in the head data storage area among four data storage areas from which data for each cycle is output. In FIG. 11, "update" is a flag indicating update, and "keep" is a flag indicating holding. In the data output unit 132, a flag indicating update is stored in a data storage area of the same cycle as the cycle in which the data output unit 131 outputs i, and a flag indicating holding is stored in the data storage area of other cycles. As a result, the flag indicating the update is input to the PE 225 to which the node that performs the arithmetic operation of the DFG 221 is allocated at the timing when i is updated.

When the CGRA 12 to which the mapping illustrated in FIG. 10 is performed performs the arithmetic operation using the data output units 131 and 132 in which the data is stored as illustrated in FIG. 11, the process for each cycle is executed as follows.

In the 0th cycle, 0 is input as i from the data output unit 131 to the PE 225, and a flag indicating update is input from the data output unit 132. In addition, in(0)(0) is input as in(i)(j) from the data output unit 131 to a PE 228.

Next, in the first cycle, the PE 225 executes the arithmetic operation using 0, and outputs the arithmetic operation result and a flag indicating update to the PE 226 to which the data transfer node is allocated. In addition, the PE 225 holds the arithmetic operation result as internal information. In addition, i is not input from the data output unit 131 to the PE 225, and a flag indicating holding is input from the data output unit 132. in(0)(0) is input from the PE 228 to a PE 229. In addition, in(0)(1) is input as in(i)(j) from the data output unit 131 to the PE 228.

Next, in the second cycle, since the flag indicates update, the PE 226 updates the arithmetic operation result held as the arithmetic operation result output from the PE 225 and outputs the updated arithmetic operation result to the PE 227. The PE 225 holds the arithmetic operation result as internal information, and outputs a flag indicating the holding to the PE 226. In addition, i is not input from the data output unit 131 to the PE 225, and a flag indicating holding is input from the data output unit 132. in(0)(0) is input from the PE 229 to the PE 227. In addition, in(0)(1) is input from the PE 228 to the PE 229. In addition, in(0)(2) is input as in(i)(j) from the data output unit 131 to the PE 228.

Next, in the third cycle, the PE 227 performs an arithmetic operation using the arithmetic operation result input from the PE 226 and in(0)(0) input from the PE 229, and outputs out(0)(1) which is an arithmetic operation result. Since the flag indicates holding, the PE 226 holds the held arithmetic operation result as it is without updating the held arithmetic operation result, and outputs the held arithmetic operation result to the PE 227. The PE 225 holds the arithmetic operation result as internal information, and outputs a flag indicating the holding to the PE 226. In addition, i is not input from the data output unit 131 to the PE 225, and a flag indicating holding is input from the data output unit 132. In addition, in(0)(1) is input from the PE 229 to the PE 227. In addition, in(0)(2) is input from the PE 304 to the PE 229. In addition, in(0)(3) is input as in(i)(j) from the data output unit 131 to the PE 228. Hereinafter, a similar process is repeated for each cycle.

Then, in the Nj-1th cycle, the PE 227 performs an arithmetic operation using the arithmetic operation result input from the PE 226 and in(0)(Nj-4) input from the PE 229, and outputs out(0)(Nj-4), which is an arithmetic operation result. Since the flag indicates holding, the PE 226 holds the held arithmetic operation result as it is without updating the held arithmetic operation result, and outputs the held arithmetic operation result to the PE 227. The PE 225 holds the arithmetic operation result as internal information, and outputs a flag indicating the holding to the PE 226. In addition, i is not input from the data output unit 131 to the PE 225, and a flag indicating holding is input from the data output unit 132. in(0)(Nj-3) is input from the PE 229 to the PE 227. in(0)(Nj-2) is input from the PE 228 to the PE 229. In addition, in(0)(Nj-1) is input as in(i)(j) from the data output unit 131 to the PE 228.

Next, in the Nj-th cycle, the PE 227 performs an arithmetic operation using the arithmetic operation result input from the PE 226 and in(0)(Nj-3) input from the PE 229, and outputs out(0)(Nj-3), which is an arithmetic operation result. Since the flag indicates holding, the PE 226 holds the held arithmetic operation result as it is without updating the held arithmetic operation result, and outputs the held arithmetic operation result to the PE 227. The PE 225 holds the arithmetic operation result as internal information, and outputs a flag indicating the holding to the PE 226. In addition, 1 is input as i from the data output unit 131 to the PE 225, and a flag indicating update is input from the data output unit 132. in(0)(Nj-2) is input from the PE 229 to the PE 227. in(0)(Nj-1) is input from the PE 228 to the PE 229. In addition, in(1)(0) is input as in(i)(j) from the data output unit 131 to the PE 228.

Next, in the Nj+1th cycle, the PE 227 performs an arithmetic operation using the arithmetic operation result input from the PE 226 and in(0)(Nj-2) input from the PE 229, and outputs out(0)(Nj-2), which is an arithmetic operation result. Since the flag indicates update, the PE 226 updates the arithmetic operation result held in the arithmetic operation result output from the PE 225 and outputs the updated arithmetic operation result to the PE 227. The PE 225 holds the arithmetic operation result as internal information, and outputs a flag indicating the holding to the PE 226. In addition, i is not input from the data output unit 131 to the PE 225, and a flag indicating holding is input from the data output unit 132. in(0)(Nj-1) is input from the PE 229 to the PE 227. in(1)(0) is input from the PE 228 to the PE 229. In addition, in(1)(1) is input as in(i)(j) from the data output unit 131 to the PE 228. Hereinafter, a similar process is repeated for each cycle until all the arithmetic operations are completed.

Here, a comparison of the number of PEs 121 to be used between the mapping by the DFG generation device 100 according to the present embodiment and the mapping in a case where the loop is rewritten using the compiler optimization technology will be described.

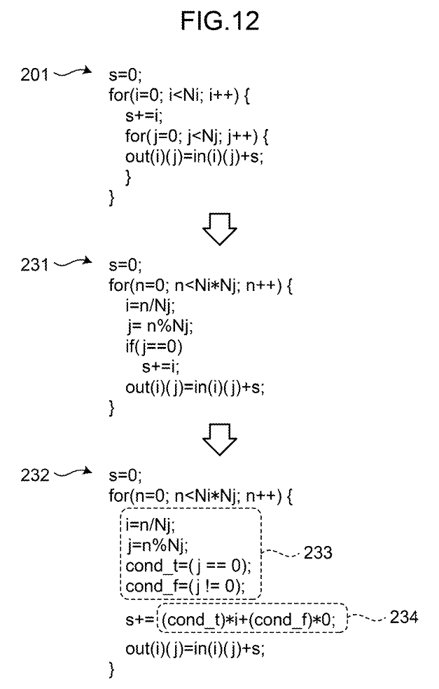

FIG. 12 is a diagram illustrating an example of loop rewriting using a compiler optimization technology. For example, the program having the code 201 is converted into a code 231 by putting the process of the outer first loop 202 of the first layer into the if statement of the inner second loop 203 of the second layer.

Next, the code 231 is converted without the if statement to be converted into a code 232. In the code 232 generated by this conversion, codes 233 and 234 are added to the code 201.

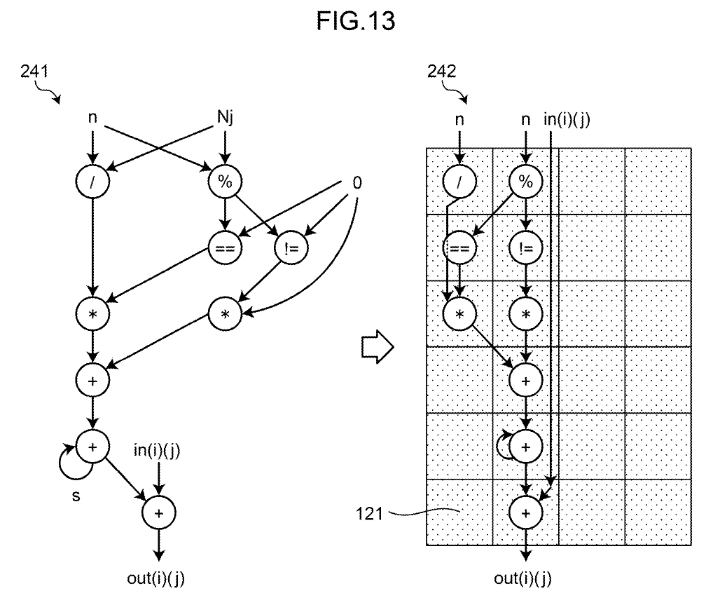

FIG. 13 is a diagram illustrating an example of mapping in a case where a loop according to the first embodiment is rewritten. A DFG 241 is a DFG created according to the rewritten code 232 of the loop using a compiler optimization technology. The DFG 241 increases in complexity depending on the code 233 and 234 added by nesting loop expansion. A mapping result 242 indicates a state in which the DFG 241 is mapped to the CGRA 12.

In a case where the loop of the code 201 is rewritten using the compiler optimization technology, when the generated DFG 241 is mapped, 9 PEs 121 are used as described in the mapping result 242. On the other hand, when the DFG 224 illustrated in FIG. 9 generated by the DFG generation device 100 according to the present embodiment is mapped, three PEs 121 are used as illustrated in FIG. 10. Therefore, in a case where the loop is rewritten using the compiler optimization technology, a large number of PEs 121 are used, and thus, the arithmetic operation efficiency is poor. In other words, according to the DFG generation device 100 according to the present embodiment, the number of PEs 121 that can be used for other arithmetic operations can be increased as compared with the case where the loop is rewritten using the compiler optimization technology. Therefore, the arithmetic operation efficiency of the PE 121 is improved, and the CGRA 12 can execute high-performance arithmetic operation.

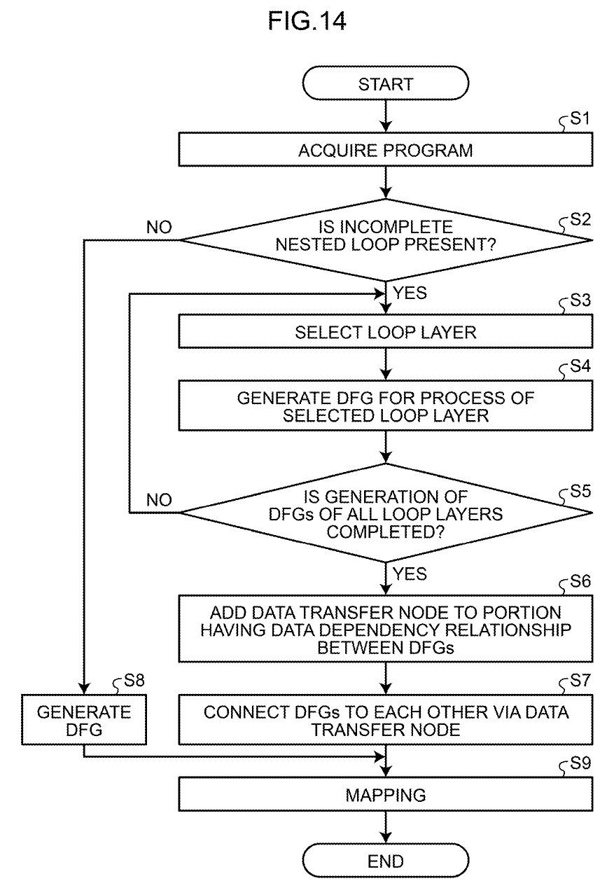

FIG. 14 is a flowchart of a DFG generation process by the DFG generation device according to the first embodiment. Next, a flow of a DFG generation process by the DFG generation device 100 according to the present embodiment will be described with reference to FIG. 14.

The structure determination unit 101 acquires a program to be executed by the CGRA 12 (step S1).

Next, the structure determination unit 101 determines whether the incomplete nested loop is present in the acquired program (step S2).

In a case where there is an incomplete nested loop (step S2: Yes), the control unit 103 requests the DFG generation unit 102 to generate a DFG for each loop layer. Upon receiving the request from the control unit 103, the DFG generation unit 102 selects one loop layer from the program (step S3).

Then, the DFG generation unit 102 generates a DFG for the process of the selected loop layer (step S4).

Next, the DFG generation unit 102 determines whether generation of DFGs of all the loop layers in the program has been completed (step S5). When a loop layer in which a DFG is not generated remains (step S5: No), the DFG generation unit 102 returns to step S3.

On the other hand, when the generation of the DFGs of all the loop layers in the program is completed (step S5: Yes), the DFG generation unit 102 outputs all the generated DFGs to the control unit 103. The control unit 103 outputs all the acquired DFGs to the DFG connection unit 104 to request connection of the DFG. The DFG connection unit 104 adds a data transfer node to a portion having a data dependency relationship between DFGs (step S6).

Then, the DFG connection unit 104 connects the DFGs to each other via the data transfer node (step S7). Thereafter, the DFG generation process proceeds to step S9.

On the other hand, in a case where there is no incomplete nested loop (step S2: No), the DFG generation unit 102 generates a DFG after performing loop expansion or the like (step S8). Thereafter, the DFG generation process proceeds to step S9.

Upon receiving the input of the generated DFG, the mapping unit 105 performs mapping on the CGRA 12 according to the input DFG (step S9).

Here, in the above description, a case where the DFG generation device 100 includes the mapping unit 105 has been described, but the configuration of the DFG generation device 100 is not limited thereto. For example, the mapping unit 105 may be disposed in another mapping device. In this case, the DFG generation device 100 does not need to include the mapping unit 105, and transmits the generated DFG to the mapping device. The mapping unit 105 of the mapping device maps the DFG received from the DFG generation device 100 to each PE 121 of the CGRA 12. In the arithmetic device 1, the DFG generation device 100 that does not include the mapping unit 105 may operate as a DFG generation function, and the mapping unit 105 may operate as a mapping function different from that of the DFG generation device 100.

As described above, the DFG generation device 100 according to the present embodiment generates a DFG for each loop layer for the program in which the incomplete nested loop is present. Then, the DFG generation device 100 generates a data transfer node that holds and outputs data and updates the held data according to the timing information, connects the DFGs by the data transfer node, and generates the DFG of the entire program.

As a result, an additional arithmetic operation in a case where the incomplete nested loop is expanded can be omitted, and the number of PEs 121 to be mapped can be reduced. Therefore, the arithmetic operation efficiency of the PE 121 can be improved, and the arithmetic operation efficiency of the entire CGRA 12 can be improved. In particular, the DFG generation device 100 according to the present embodiment can obtain more effects by applying to the static schedule CGRA in which the input/output timing of data between the PEs 121 and the arithmetic operation timing of the PE 121 are determined at the time of mapping.

### (b) Second Embodiment

Next, a second embodiment will be described. The DFG generation device 100 according to the present embodiment is also represented by the block diagram of FIG. 3. In the program, a process in a loop may be executed in parallel to improve throughput. The DFG generation device 100 according to the present embodiment generates and maps a DFG of a program compatible with parallel execution. In the following description, description of operation of each unit similar to that of the first embodiment may be omitted.

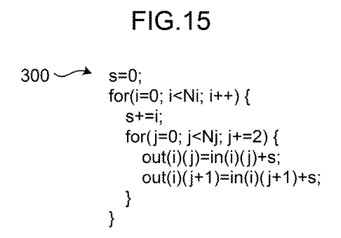

FIG. 15 is a diagram illustrating an example of a program compatible with parallel execution. In the present embodiment, a program having a code 300 illustrated in FIG. 15 will be described as an example. In the code 300, a process of out (i) (j) = in (i) (j) + s and a process of out (i) (j + 1) = in (i) (j + 1) + s are executed in parallel in the second loop. Here, for simplification of description, Nj will be described as an even number. In a case where the process is executed in parallel as in the code 300, the PEs 121 for performing the respective arithmetic operations are arranged in parallel in the CGRA 12.

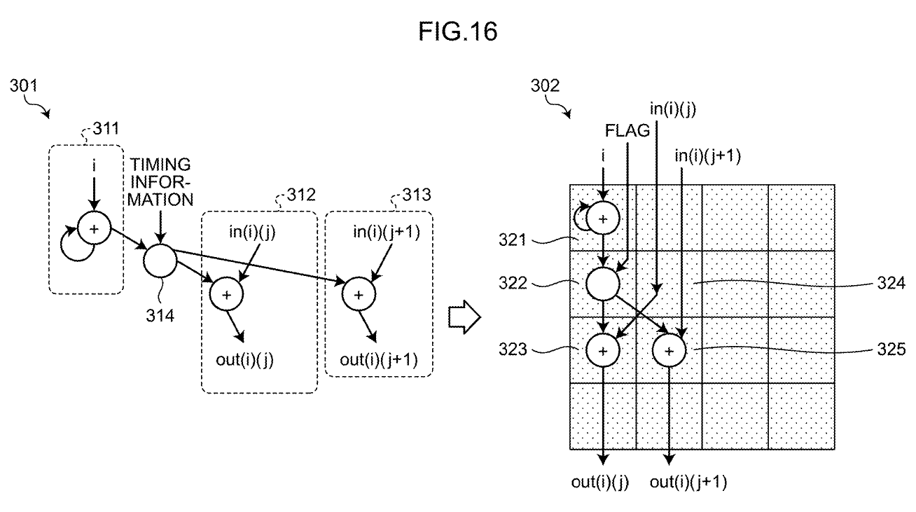

FIG. 16 is a diagram illustrating an example of a DFG and mapping according to the second embodiment. With respect to the code 300, the DFG generation device 100 generates a DFG by executing the process similar to that in a case where parallel execution of process is not included for each of two processes to be executed in parallel.

The DFG generation unit 102 sequentially selects the loop layers and generates the DFG for each of the first loop and the second loop. The DFG generation unit 102 generates a DFG 311 for the first loop of the code 300. In addition, the DFG generation unit 102 generates the respective DFGs 312 and 313 to be executed in parallel for the second loop of the code 300.

The DFG connection unit 104 generates the data transfer node 314 that holds and outputs the arithmetic operation result of the DFG 311 and updates the held arithmetic operation result according to the input timing information. Next, the DFG connection unit 104 disposes the data transfer node 314 in a portion having a data dependency relationship between the first loop and the second loop. Then, the DFG connection unit 104 connects the DFG 311 and each of the DFGs 312 and 313 via the data transfer node 314 to generate a DFG 301. In this way, when the process is executed in parallel, the DFG of one loop is connected to each DFG of the process executed in parallel of the other loop via the data transfer node.

The mapping unit 105 maps the DFG 301 to the CGRA 12 as indicated by the mapping result 302. Here, the mapping unit 105 performs mapping such that a flag indicating update or holding as timing information is input to the PE 322 to which the data transfer node 314 is allocated.

In the mapping result 302, four PEs 121 of PEs 321, 322, 323, and 325 are used. Furthermore, although a case where a degree of parallelism is 2 has been described here, for example, in a case where the degree of parallelism is P, (2 + P) PEs121 are used for the process indicated by the code 300.

Here, in the present embodiment, a case where the second loop includes parallel execution of the process has been described, but the same applies to a case where the first loop includes parallel execution of the process. In this case, the DFG generation unit 102 generates the DFG for each process executed in parallel in the first loop. Then, the DFG connection unit 104 connects each DFG for each process of the first loop and the DFG of the second loop. Furthermore, the same applies to a case where each of the first loop and the second loop includes parallel execution of the process. That is, the DFG generation unit 102 generates the DFG for each process executed in parallel for each of the first loop and the second loop. Then, the DFG connection unit 104 connects each DFG for each process of the first loop and each DFG for each process of the second loop.

As described above, when a plurality of first processes is executed in parallel in the first loop, the DFG generation unit 102 generates the first individual DFG for each first process as the first DFG. In addition, when a plurality of second processes is executed in parallel in the second loop, the DFG generation unit 102 generates the second individual DFG for each second process as the second DFG. When a first individual DFG is generated, the DFG connection unit 104 connects the first individual DFG and a second DFG, and when a second individual DFG is generated, the DFG connection unit generates a third DFG of the program by connecting the first DFG and the second individual DFG.

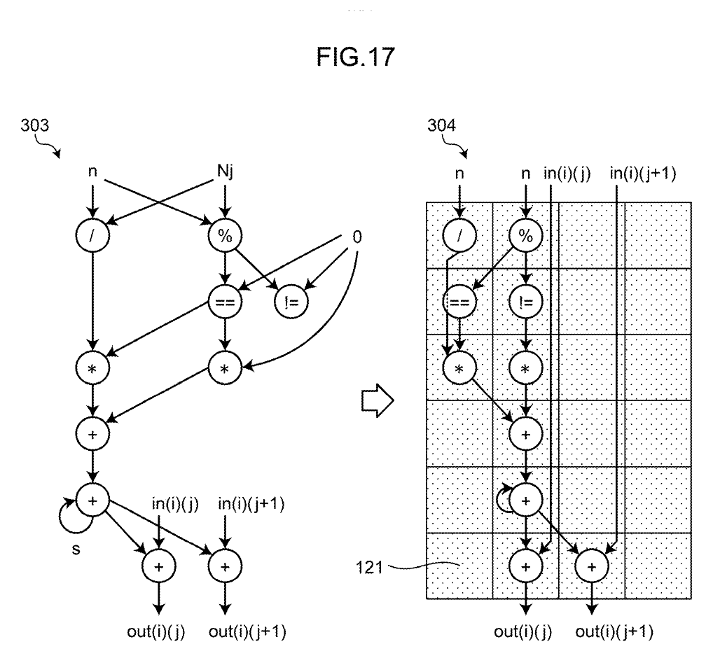

FIG. 17 is a diagram illustrating an example of mapping in a case where a loop according to the second embodiment is rewritten. Next, mapping in a case where the loop of the code 300 is rewritten using the compiler optimization technology will be described with reference to FIG. 17.

Similarly to the case where the parallel execution of the process is not included, the code 300 is converted by putting the process of the outer first loop into the if statement of the inner second loop and further performing conversion to eliminate the if statement. Then, for example, a DFG 303 illustrated in FIG. 17 is generated for the code generated by the conversion for the code 300. The DFG 303 has a structure in which a node that performs an arithmetic operation for parallel execution is added to the DFG 241 in a case where parallel execution of the process illustrated in FIG. 13 is not included.

For example, the DFG 303 is mapped to the CGRA 12 as illustrated in the mapping result 304. In the mapping result 304, the PE 121 to which a node that performs the arithmetic operation for parallel execution is allocated is added to the mapping result 242 in a case where parallel execution of the process illustrated in FIG. 13 is not included.

In the mapping result 304, ten PEs 121 are used. Furthermore, although a case where a degree of parallelism is 2 has been described here, for example, in a case where the degree of parallelism is P, (8 + P) PEs 121 are used for the process indicated by the code 300.

As described above, in the case of the code 300 in which the degree of parallelism for the parallel execution of the process is 2, ten PEs 121 are used when the DFG generated using the compiler optimization technology is mapped, but when the DFG generation device 100 is used, four PEs 121 are used. In this case, the use rate of the PE 121 in each method is 10/4 = 2.5.

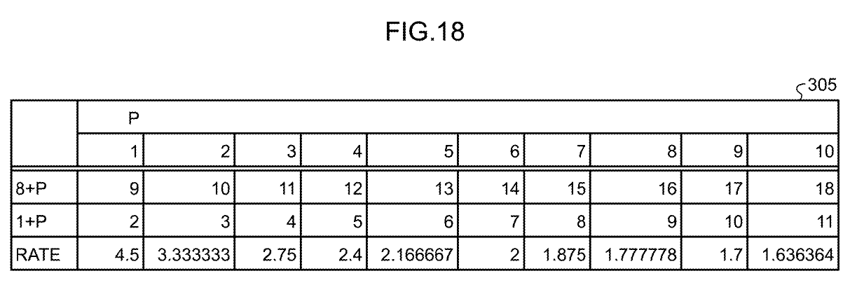

FIG. 18 is a diagram illustrating comparison of the number of PEs to be used in a parallel execution program. Table 305 describes the number of PEs121 to be used and the use rate for each degree of parallelism between the case of mapping the DFG generated by using the compiler optimization technology and the case of using the DFG generation device 100. A line described as (8 + P) indicates the number of PEs 121 when the DFG generated using the compiler optimization technology is mapped. In addition, a row described as (1 + P) indicates the number of PEs 121 when the DFG generated by using the DFG generation device 100 is mapped. In addition, the row described as the ratio indicates the use rate of the PE 121 for each degree of parallelism.

As described in Table 305, the use rate decreases as the degree of parallelism increases, but when the degree of sequence is 2 or 3, the number of PEs121 to be used can be suppressed to about 1/3 by using the DFG generation device 100. In addition, since the process of the code 300 is simple, the use rate described in Table 305 is obtained, but in an actual program, the process of the inner second loop is more complicated, and when the degree of parallelism is 4 or more, the DFG often has a more complicated structure rather than a structure in which the process is simply arranged. In that case, even when the degree of parallelism is 4 or more, the effect of reducing the number of PEs 121 to be used can be obtained by using the DFG generation device 100.

As described above, the DFG generation device 100 according to the present embodiment generates a DFG for each loop layer for the program that includes the incomplete nested loop and executes the process in parallel. For the loop including parallel execution of the process, the DFG generation device 100 generates a DFG for each process to be executed in parallel. Then, the DFG generation device 100 generates a data transfer node that holds and outputs data and updates the held data according to the timing information, connects the DFGs by the data transfer node, and generates the DFG of the entire program.

As described above, even in a program that executes the process in parallel, an additional arithmetic operation in a case where the incomplete nested loop is expanded can be omitted, and the number of PEs 121 to be mapped can be reduced. Therefore, the arithmetic operation efficiency of the PE 121 can be improved, and the arithmetic operation efficiency of the entire CGRA 12 can be improved.

### (c) Third Embodiment

Next, a third embodiment will be described. The DFG generation device 100 according to the present embodiment is also represented by the block diagram of FIG. 3. The DFG generation device 100 according to the present embodiment generates and maps a DFG of a program having a loop layer of 3 or more. In the following description, description of operation of each unit similar to that of the first embodiment may be omitted.

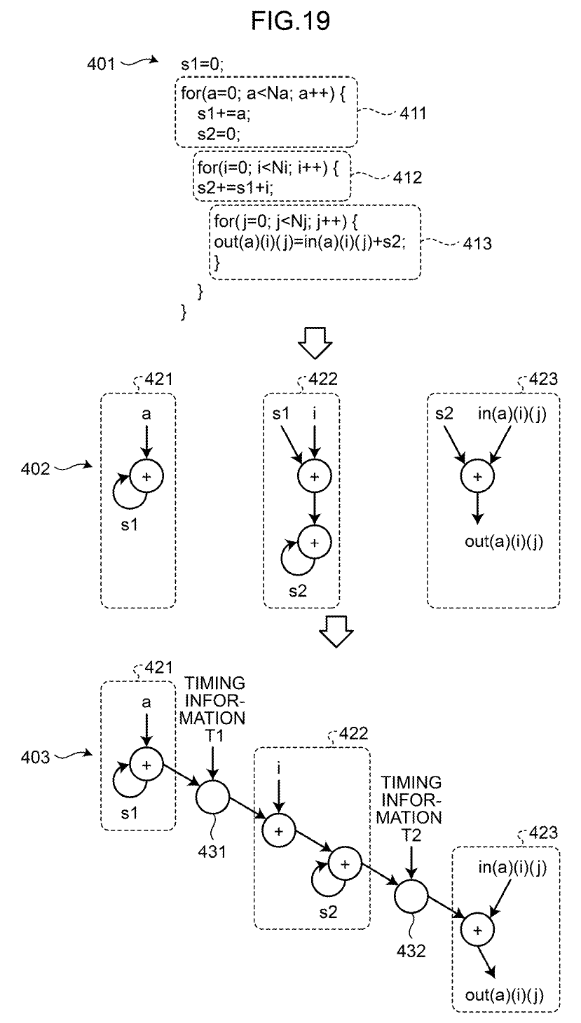

FIG. 19 is a diagram illustrating an example of generation of a DFG by a DFG generation device according to a third embodiment. In the present embodiment, a program having a code 401 illustrated in FIG. 19 will be described as an example. The code 401 includes a first loop 411 of a first layer, a second loop 412 of a second layer, and a third loop 413 of a third layer. The second loop 412 performs an arithmetic operation using the arithmetic operation result of the first loop 411. In addition, the third loop 413 performs an arithmetic operation using the arithmetic operation result of the second loop 412.

The DFG generation unit 102 sequentially selects the loop layers and generates the DFG for each of the first loop 411, the second loop 412, and the third loop 413. The DFG generation unit 102 generates a DFG 421 for the first loop 411 of the code 401. In addition, the DFG generation unit 102 generates a DFG 422 for the second loop 412 of the code 401. In addition, the DFG generation unit 102 generates a DFG 423 for the third loop 413 of the code 401.

The DFG connection unit 104 receives timing information T1 and generates the data transfer node 431 that updates the data to be held according to the timing information T1. Further, the DFG connection unit 104 receives timing information T2 and generates the data transfer node 432 that updates the data to be held according to the timing information T2.

Next, the DFG connection unit 104 disposes the data transfer node 431 in a portion having a data dependency relationship between the first loop 411 and the second loop 412. In addition, the DFG connection unit 104 disposes the data transfer node 432 in a portion having a data dependency relationship between the second loop 412 and the third loop 413. Then, the DFG connection unit 104 connects the DFG 421 and the DFG 422 by the data transfer node 431, and connects the DFG 422 and the DFG 423 by the data transfer node 432 to generate a DFG 403.

As described above, when the third loop of the third layer included in the second loop is present, the DFG generation unit 102 generates the third DFG corresponding to the third loop. Then, the DFG connection unit 104 generates a second data transfer node that holds the second arithmetic operation result output from the second DFG, updates the held second arithmetic operation result, and outputs the held second arithmetic operation result to the third DFG. Next, the DFG connection unit 104 is disposed between an output portion of the second arithmetic operation result in the second DFG and an input portion of the second arithmetic operation result in the third DFG, and connects the second DFG and the third DFG by the second data transfer node to generate the third DFG.

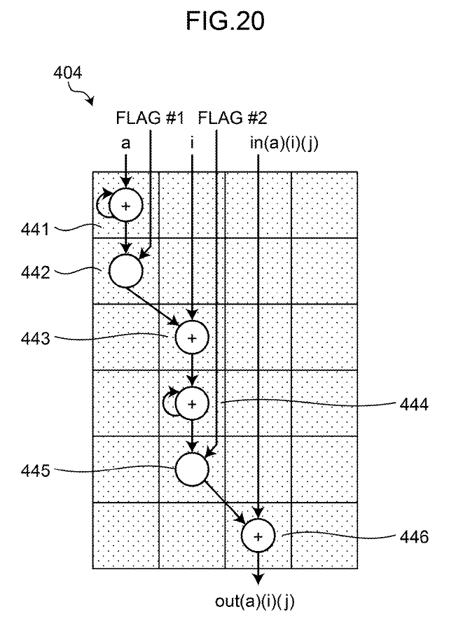

FIG. 20 is a diagram illustrating an example of mapping by the DFG generation device according to the third embodiment. The mapping unit 105 maps the DFG 403 to the CGRA 12 as indicated by a mapping result 404. Here, the mapping unit 105 performs mapping such that a flag #1 indicating update or holding as timing information T1 is input to the PE 442 to which the data transfer node 431 is allocated. Also, the mapping unit 105 performs mapping such that a flag #2 indicating update or holding as timing information T2 is input to the PE 445 to which the data transfer node 432 is allocated. In the mapping result 404, five PEs 121 of the PE 441 to 445 are used.

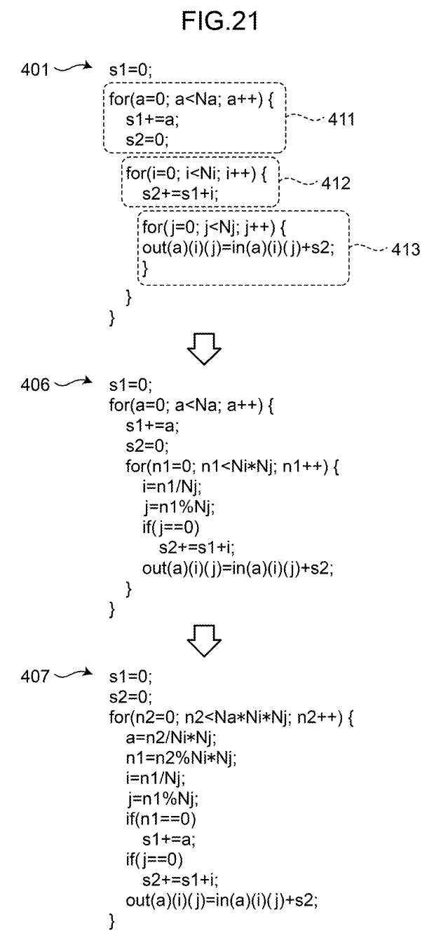

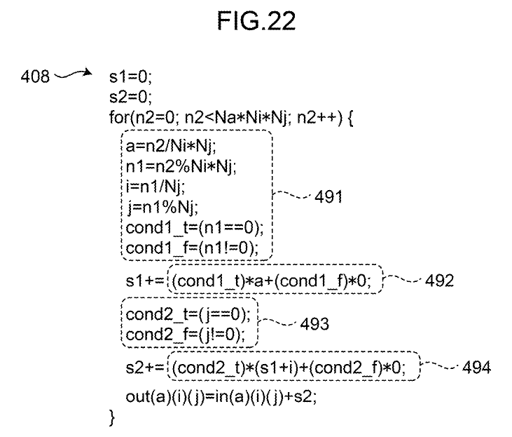

FIG. 21 is a first diagram illustrating an example of loop rewriting using a compiler optimization technology according to the third embodiment. Further, FIG. 22 is a second diagram illustrating an example of loop rewriting using a compiler optimization technology according to the third embodiment. Next, a case where the loop of the code 401 is rewritten using the compiler optimization technology will be described with reference to FIGS. 21 and 22.

The code 401 is converted into a code 406 by putting the process of the second loop 412 into the if statement of the third loop 413. Further, the code 406 is converted into a code 407 by putting the process of the first loop 411 into the if of the third loop 413.

Then, the code 407 is converted without the if statement, and is converted into a code 408 illustrated in FIG. 22. In the code 408, codes 491 to 494 are added to the code 401 before conversion. The number of PEs 121 allocated according to the arithmetic operation of the added codes 491 to 494 increases.

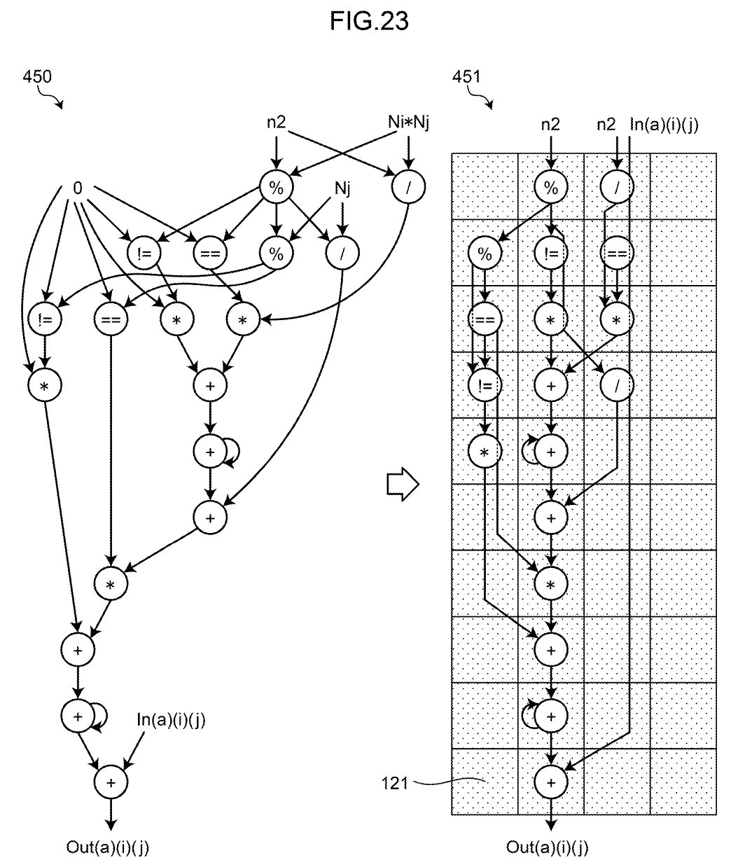

FIG. 23 is a diagram illustrating an example of mapping in a case where a loop according to the third embodiment is rewritten. For the code 408 illustrated in FIG. 22, for example, a DFG 450 illustrated in FIG. 23 is generated. Since the loop layer is three incomplete nested loops, the DFG 450 is more complicated than the DFG 241 in which the loop layer illustrated in FIG. 13 is two, and the number of nodes is increased from 9 to 18.

For example, the DFG 450 is mapped to the CGRA 12 as illustrated in the mapping result 451. In the mapping result 451, 18 PEs 121 are used.

As described above, in a case where the loop layer is the codes 401, 18 PEs 121 are used when the DFG generated using the compiler optimization technology is mapped, but when the DFG generation device 100 is used, six PEs 121 are used. In this case, the use rate of the PE 121 in each method is 18/6 = 3.

In addition, the DFG generated by using the compiler optimization technology has a dramatically increased complexity as the loop layer of the incomplete nested loops increases, and therefore the number of PEs 121 to be used increases sharply. In addition, the DFG generated by using the compiler optimization technology becomes more complicated according to the loop variables such as a, i, and j in the code 401 and the conditional statement, and the complexity is further increased accordingly, so that the PE 121 to be used is further increased.

As described above, the DFG generation device 100 according to the present embodiment generates a DFG for each loop layer for the program in which the incomplete nested loop having three or more loop layers is present. Next, the DFG generation device 100 generates, for each loop, a data transfer node that holds and outputs data and updates the held data according to the timing information. Then, the DFG generation device 100 connects the DFGs of the loops to each other at the generated data transfer nodes to generate a DFG of the entire program.

As described above, even in a program in which an incomplete nested loop having three or more loop layer is present, an additional operation in a case where the incomplete nested loop is expanded can be omitted, and the number of PEs 121 to be mapped can be reduced. Therefore, the arithmetic operation efficiency of the PE 121 can be improved, and the arithmetic operation efficiency of the entire CGRA 12 can be improved.

In one aspect, the present invention can improve arithmetic operation efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. An optimization device comprising:
a processor configured to:
generate a first DFG corresponding to a first loop and a second DFG corresponding to a second loop for a program in which an incomplete nested loop in which a first arithmetic operation result for each loop of the first loop is sequentially used in an arithmetic operation for each loop of the second loop of a second layer included in the first loop of a first layer is present; and
arrange a first data transfer node between an output portion of the first arithmetic operation result in the first DFG and an input portion of the first arithmetic operation result in the second DFG, the first data transfer node holding the first arithmetic operation result output from the first DFG, updating the held first arithmetic operation result, and outputting the held first arithmetic operation result to the second DFG, connect the first DFG and the second DFG by the first data transfer node, and generate a third DFG of the program.

2. The optimization device according to claim 1, wherein the processor is further configured to determine whether the program includes the incomplete nested loop,
wherein the processor is configured to generate the first DFG and the second DFG when the program is determined to include the incomplete nested loop.

3. The optimization device according to claim 1, wherein the processor is configured to generate a third DFG including the first data transfer node to which timing information is input and which updates the first arithmetic operation result held based on the timing information.

4. The optimization device according to claim 3 wherein the processor is configured to generate the third DFG including the first data transfer node that updates the held first arithmetic operation result when the flag indicating the holding or update is input as the timing information and the flag indicating the update is input.

5. The optimization device according to claim 3, wherein the processor is configured to generate the third DFG including the first data transfer node that updates the held first arithmetic operation result when the information indicating a data holding period is input as the timing information and the data holding period has elapsed.

6. The optimization device according to claim 1, wherein the processor is further configured to map the third DFG generated by the DFG connection unit to a CGRA.

7. The optimization device according to claim 1, wherein
the processor is configured to:
generate a first individual DFG for each of first processes as the first DFG when a plurality of the first processes are executed in parallel in the first loop, and generates a second individual DFG for each of second processes as the second DFG when a plurality of the second processes are executed in parallel in the second loop, and
connect each of the first individual DFGs and the second DFG when the first individual DFG is generated, and connect each of the first DFG and the second individual DFG to generate a third DFG of the program when the second individual DFG is generated.

8. The optimization device according to claim 1, wherein
the processor is configured to:
in a case where a third loop of a third layer included in the second loop is present, generate a third DFG corresponding to the third loop, and
arrange a second data transfer node that holds a second arithmetic operation result output from the second DFG, updates the held second arithmetic operation result, and outputs the held second arithmetic operation result to the third DFG between an output portion of the second arithmetic operation result in the second DFG and an input portion of the second arithmetic operation result in the third DFG, connect the second DFG and the third DFG by the second data transfer node, and generate the third DFG.

9. An optimization method comprising:
generating a first DFG corresponding to a first loop and a second DFG corresponding to a second loop for a program in which an incomplete nested loop in which a first arithmetic operation result for each loop of the first loop is sequentially used in an arithmetic operation for each loop of the second loop of a second layer included in the first loop of a first layer is present; and
arranging a first data transfer node between an output portion of the first arithmetic operation result in the first DFG and an input portion of the first arithmetic operation result in the second DFG, the first data transfer node holding the first arithmetic operation result output from the first DFG, updating the held first arithmetic operation result, and outputting the held first arithmetic operation result to the second DFG, connecting the first DFG and the second DFG by the first data transfer node, and generating a third DFG of the program, using a processor.
